(19) United States
(12) Patent Application Publication
(10) Pub. No.: US 2007/0145062 A1
(43) Pub. Date: Jun. 28, 2007

(54) Supply roll surface drive for a dispensing apparatus

(76) Inventors: John Formon, Appleton, WI (US); Russell Wieser, Appleton, WI (US)

Correspondence Address: YOUNG & THOMPSON, 745 SOUTH 23RD STREET, 2ND FLOOR, ARLINGTON, VA, 22202, US

(21) Appl. No.: 11/318,778

(22) Filed: Dec. 28, 2005

(51) Int. Cl. G07F 11/72

(52) U.S. Cl. 221/30

(57) ABSTRACT

An apparatus that dispenses a sheet of absorbent material from a roll of absorbent material includes a housing and a drum in the housing. A cutting device is incorporated in the drum. A one-way bearing on a shaft of the drum enables the drum to rotate only in one direction upon activation of the drum. A tensioning device provides tension to a strip of paper material passing between the tensioning device and the drum. The apparatus also includes a supply roll surface drive that controls rotation of the roll of absorbent material. The supply roll surface drive includes two independently rotatable pulleys and a belt wrapped around the pulleys. The belt contacts the roll of paper towels along a plurality of contact points to control rotation of the roll of absorbent material.

### FIELD OF THE INVENTION

The invention relates to an apparatus for dispensing absorbent material from a roll of absorbent material such as paper towels, toilet paper or other wiping materials.

### BACKGROUND OF THE INVENTION

In conventional sheet dispensing apparatus, a supply roll of absorbent material is incrementally dispensed through a dispensing opening in a housing. Sheets pass from the supply roll, while still connected to the roll, and wind around a tensioning device and a drum. The drum may contain a cutting or perforating device or a cutting device may be at the dispensing opening to separate the sheets from the roll upon dispensing.

A problem with conventional devices is that when the sheets are dispensed from the supply roll, the force required to pull the sheets around the tensioning device and separate the sheets from the supply roll, causes the supply roll to over rotate. This over rotation in turn causes excess sheet material still attached to the supply roll to be unrolled from the supply roll and remain within the housing. The unrolled and as yet undispensed sheet material tends to jam the tensioning device and/or the drum, so that the dispensing device must be serviced to remove the jam.

U.S. Pat. No. 6,196,102 to Granger has attempted to solve the above-noted problem by including a component that is continuously in contact with the supply roll, and relates the motion of the roll to that of the drum or tensioning device. The device of Granger is a roller on the end of a lever. The roller contacts the supply roll and is driven by a drive belt connected to the drum or tensioning device. The roller of Granger is designed to help control the unwinding of the supply roll.

However, the contact between the roller of Granger and the supply roll is essentially a point-to-point contact that thus poorly compensates for irregularities in the supply roll such as “out of roundness”, wrinkles and uneven surfaces.

### SUMMARY OF THE INVENTION

An object of the invention is to overcome the shortcomings of the prior art, or to alleviate the shortcomings of the prior art at least in part.

Another object of the invention is to have a supply roll contact device that better compensates for irregularities on the supply roll.

Yet another object of the preferred embodiments of the invention is to decrease the contact force required to drive the supply roll.

### BRIEF DESCRIPTION OF THE DRAWINGS

The above and other objects and advantages of the invention will become apparent from the following detailed description of preferred embodiments thereof, given with reference to the accompanying drawing figures, wherein:

FIG. 1 is a cross-sectional view of a dispensing apparatus including a first embodiment of a supply roll surface drive of the present invention;

FIG. 2 is an enlarged partial view of a supply roll surface drive of the present invention including various supporting elements;

FIG. 3 is a schematic view of the first embodiment;

FIG. 4 is an exploded view of a dispenser cassette of the present invention;

FIG. 5 is a schematic view showing how the dispenser cassette of FIG. 4 may be assembled into a dispenser housing;

FIG. 6 shows an embodiment of a supply roll drive belt; and

FIG. 7 shows an embodiment of a drum/tensioning device drive belt.

### DETAILED DESCRIPTION OF THE PREFERRED EMBODIMENTS

The present invention departs from the device described in U.S. Pat. No. 6,196,102, the entirety of which patent is hereby expressly incorporated by reference.

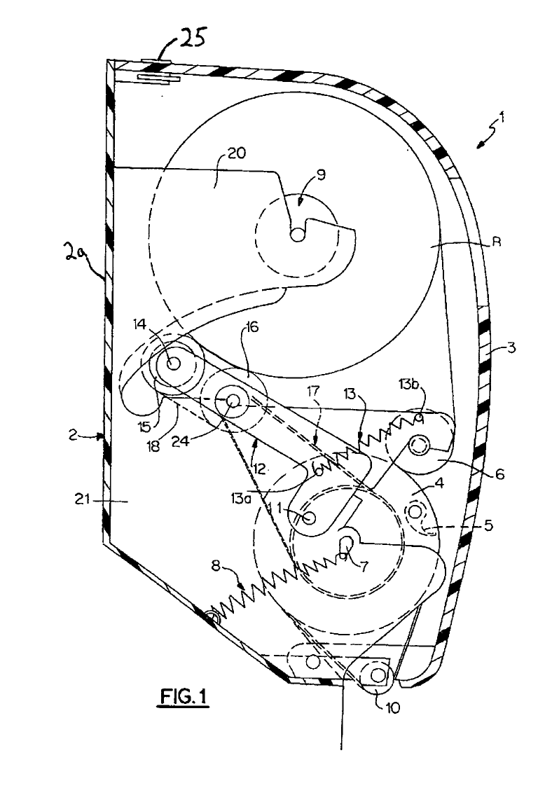

FIG. 1 shows a dispensing apparatus 1 that includes a housing 2 having a rear portion 2a. The housing 2 includes a cover 3, which may be articulated to the rear portion 2a or may be connected to the rear portion 2a using a snap-fit connection or other connection. The cover 3 is retained in the closed position using a lock assembly 25.

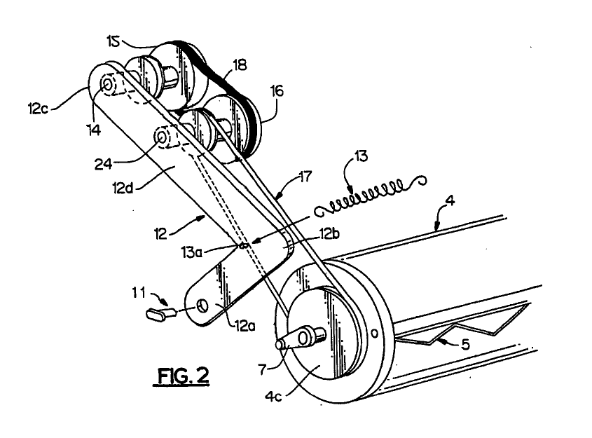

Within the housing 2 there is a drum 4 around which a roll of absorbent material R is partially wound when the dispenser is in use. The drum 4 may include a cutting device 5 that rotates with the drum 4 and that extends from a slot (see FIG. 2) in the drum 4 upon actuation of the drum 4. A return mechanism that may include an eccentric arm 7 and a spring 8 help the drum 4 to complete its rotation.

A preferred embodiment of the cutting device 5 is described in co-pending U.S. patent application Ser. No. 10/812,183, the entirety of which is hereby incorporated by reference.

To provide tension to the roll of absorbent material R, a tensioning device 6 is provided. A web from the roll of material R is first partially wound around the tensioning device 6 and then is partially wound around the drum 4.

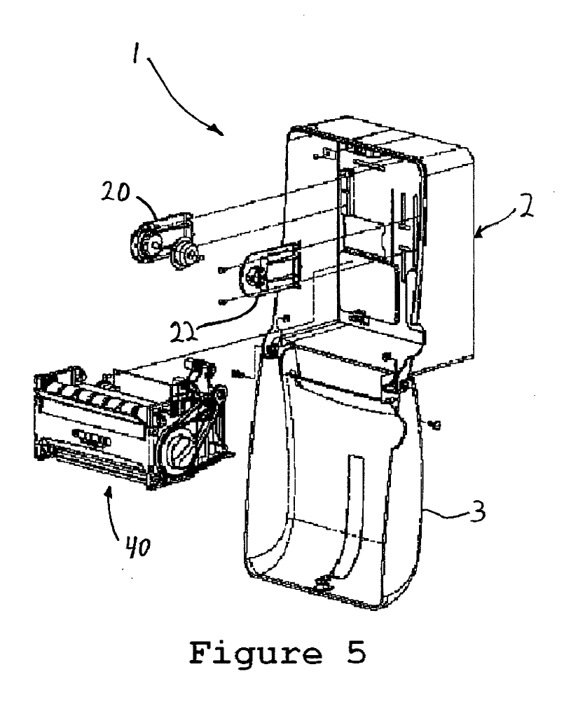

The roll of material R may be held upon a roll receiver 9, which in turn may be supported by a pair of roll support arms 20, 22. The roll support arms 20, 22 may be located in an upper part of housing 2 as seen in FIGS. 1 and 5. Only one of the pair of roll support arms, support arm 20 is shown in FIG. 1. In a preferred embodiment, the roll support arms 20, 22 are removable from the housing 2 as seen in FIG. 5.

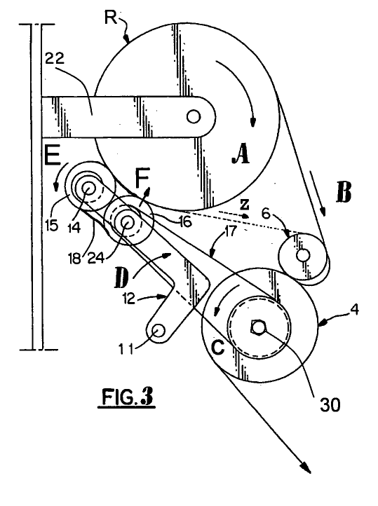

In operation, as seen in FIG. 3, the web of absorbent material may be unwound in the direction A from the roll of absorbent material R toward tensioning device 6 along the path B and wound around and between the tensioning device 6 and the drum 4. In another embodiment as seen in dashed lines in FIG. 3, the web of absorbent material may be unwound from the roll of absorbent material R along the path Z around the drum 4, by rotating roll R in the opposite direction. In that case, drive belt 17 would be crossed to reverse the rotation of roll R, as shown in FIG. 7 and as discussed below.

The web unwinds from the drum 4 in the direction C and then exits the housing 2 from a dispensing opening (not numbered). The dispensing opening may have a follow-on roller 10 therein as seen in FIG. 1 to protect a user's hands from the point of dispensing and to guide the web through the dispensing opening. As the web is being unwound, a supply roll surface drive mechanism contacts the roll of material.

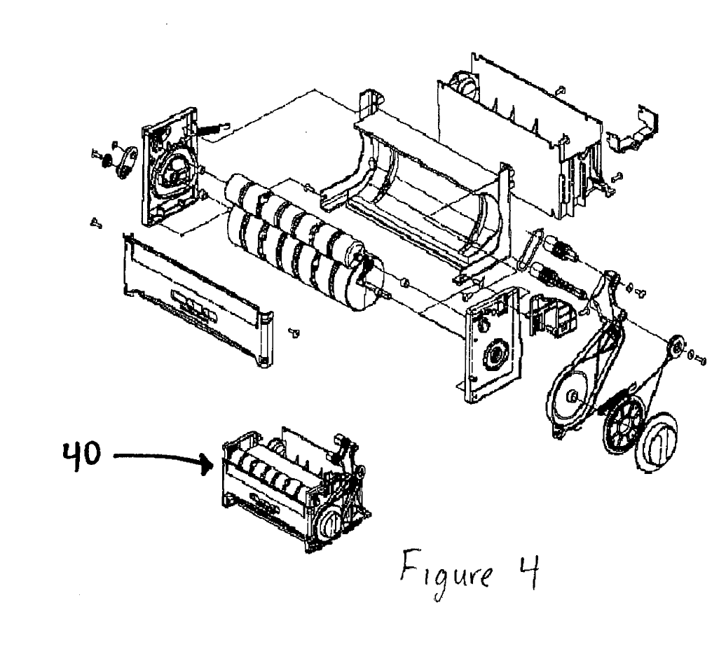

As shown in FIG. 2, the supply roll surface drive mechanism is referred to generally at 12. This mechanism includes a lever having a first leg 12a and a second leg 12d. The lever may be hingedly connected to the housing 2 through shaft 11. Alternatively, in the embodiments seen in FIGS. 4 and 5, the lever may be part of a modular cassette 40 that also includes the drum 4 and the tensioning roller 6. The cassette is removably connectable to the housing 2 at rear portion 2a as shown in FIG. 5.

The lever works in opposition to an elastic element, which is shown as spring 13, although other elements that apply tension to the lever are also contemplated. The spring 13 places the lever in tension generally in a direction D as seen in FIG. 3. A first end 13a of spring 13 may be connected to leg 12a near an inner bent part 12b and a second end 13b of spring 13 is connected to either housing 2 or flange 21 that extends from a rear portion of the housing.

At an upper end 12c of leg 12d, a pair of pulleys 15, 16 are connected. Pulley 15 is preferably freely rotatable about shaft 14 and pulley 16 is preferably freely rotatable about shaft 24. A supply roll drive belt 18 is wrapped around the pulleys 15, 16 and rotates with the pulleys 15, 16. The supply roll drive belt continuously contacts the roll of absorbent material R with a force F and assists in rotating the roll of absorbent material R. Supply roll drive belt 18 may be a flat belt or may instead be a flexible annular ring in the nature of an 0-ring, that travels around pulleys 15, 16.

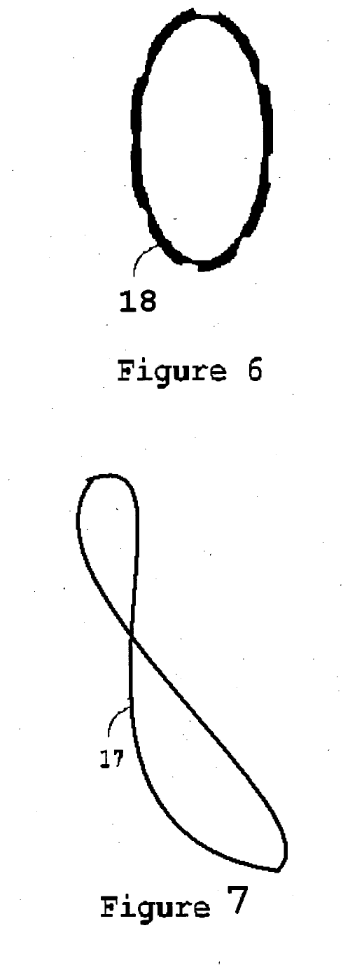

In a presently-preferred embodiment as seen in FIG. 6, supply roll drive belt 18 is annular with reduced cross-section areas so that the belt has a segmented profile. The segmented portion of the supply roll drive belt 18 allows stresses that are generated in the web of material during converting or dispensing to be relieved. This reduction in stress improves at least in part the paper tracking as the web of absorbent material is dispensed from the dispensing apparatus 1.

The roll of material R is urged in rotation not only by tension applied to the web of absorbent material that extends from the dispensing opening, but also by the rotation of the supply roll drive belt 18. This is due to supply roll drive belt 18 being driven in direction E by rotation of the drum 4. Alternatively, the supply roll drive belt 18 may be driven using the tensioning device.

In a first embodiment, as seen in FIGS. 2 and 3, the drive belt 17 is wound around the drum 4 and is wound around shaft 24. However, as set forth above, the drive belt 17 or another drive belt may instead be wound around the shaft of the tensioning device 6. In the first embodiment, due to the belt 17, when the drum 4 rotates to dispense a sheet of material from the roll of absorbent material R, the rotation of the drum causes the shaft 24 to rotate which in turn causes the supply roll drive belt 18 to rotate, which assists in the rotation of the roll of absorbent material.

Conversely, the belt 18 also exerts a braking effect on the roll of absorbent material as the drum decelerates during the end of a dispensing cycle, thereby to inhibit the undesired over rotation phenomenon described above, and this more reliably than with the structure provided in U.S. Pat. No. 6,196,102.

The supply roll drive belt 18 may be flat to maximize the contact patch between the supply roll drive belt 18 and the roll of material R, or may be annular, as noted above. In addition, having the supply roll drive belt 18 extending between two or more pulleys also creates a large contact patch between the supply roll drive belt 18 and the roll of absorbent material R. A large contact patch is advantageous to provide flexibility and to be able to conform to any irregularities that may be present in the roll.

In the embodiment of FIG. 2, a tensioned flat belt is used as the drive belt 17 for driving pulley 16 and ultimately, the supply roll drive belt 18. However, other ways of driving the supply roll drive belt 18 are also contemplated including gears, toothed belts, or circular cross-section belts. As also seen in FIG. 2, the drum 4 may include a flange 4c having a groove therein for receiving the belt 17.

As set forth above, the web of material could unroll in a counter-clockwise direction as shown by the dotted lines in FIG. 3 so that the web of material comes off the roll of material along the path Z. In this embodiment, as seen in FIG. 7, the drive belt 17 is in a FIG. 8 or crossed configuration to prevent drive belt 17 from interfering with the web of material as the web of material unrolls from the roll of material R.

In a presently-preferred embodiment of the present invention, the shaft on which the drum 4 rotates includes a one-way bearing enabling the drum 4 to rotate only in one direction, upon activation of the actuating device. In the embodiment of FIG. 3, the one-way bearing 30 enables rotation only in the direction C, for example.

The invention has been described in detail with respect to the preferred embodiments. However, it will be apparent to those of skill in the art that changes or modifications may be made without departing from the true spirit of the invention. The invention should not be limited by these embodiments and should be defined by the appended claims.

What is claimed is:

1. An apparatus for dispensing sheets of absorbent material from a roll of absorbent material, said apparatus comprising:
a housing;
a drum in said housing;
a cutting or perforating device incorporated in the drum;
a roll receiver adapted to hold a roll of absorbent material;
a tensioning device that tensions a strip of absorbent material passing between said tensioning device and said drum;
a supply roll surface drive that controls rotation of a roll of absorbent material, said supply roll surface drive including plural pulleys and a first belt wrapped around said plural pulleys, said first belt contacting a roll of absorbent material along a plurality of contact points; and
a drive mechanism connected between one of said plural pulleys and said drum or said tensioning device.

2. The apparatus as claimed in claim 1, wherein said drum includes a one-way bearing enabling said drum to rotate only in one direction.

3. The apparatus as claimed in claim 1, wherein said supply roll surface drive includes a lever and an elastic element attached to said lever, said lever being pivotably movable so that said first belt remains in contact with a roll of absorbent material from an initial diameter of a roll of absorbent material to a second smaller diameter in which absorbent material is depleted from a roll of absorbent material.

4. The apparatus as claimed in claim 1, further comprising a removable cassette, wherein said drum, said tensioning device and said supply roll surface drive are contained within said cassette as a unit.

5. The apparatus as claimed in claim 1, wherein said drive mechanism is a second belt and wherein said drum includes a flange defining a groove to receive said second belt.

6. The apparatus as claimed in claim 1, wherein said first belt is a flat belt.

7. The apparatus as claimed in claim 1, wherein said first belt is annular having sections with a reduced cross-section.

8. The apparatus as claimed in claim 1, wherein said drive mechanism is a second belt arranged in a FIG. 8 configuration.

9. An apparatus for dispensing sheets from a roll of absorbent material, said apparatus comprising:
a housing;
a drum in said housing;
a serrated cutting device incorporated in said drum;
a one-way bearing in said drum enabling said drum to rotate only in one direction;
a roll receiver adapted to hold a roll of absorbent material;
a tensioning device adapted to feed and tension a strip of absorbent material passing between said tensioning device and said drum,
a supply roll surface drive that controls rotation of a roll of absorbent material, said supply roll surface drive including two pulleys that are rotatable on separate axes and a first belt wrapped around said two pulleys; and
means for driving said two pulleys connected between one of said two pulleys and said drum or said tensioning device.

10. The apparatus as claimed in claim 9, wherein said first belt is a flat belt.

11. The apparatus as claimed in claim 9, wherein said means for driving the drum is one of gears, a toothed belt, a flat belt and a circular cross-section belt.

12. The apparatus as claimed in claim 11, wherein said means for driving the drum is one a toothed belt, a flat belt and a circular cross-section belt that is crossed over itself in a FIG. 8 configuration.

13. The apparatus as claimed in claim 9, wherein said first belt is annular, portions of said first belt having a reduced cross-section.

14. An apparatus for dispensing a sheet of absorbent material from a roll of absorbent material, said apparatus comprising:
a housing;
a roll receiver in said housing adapted to hold a roll of absorbent material;
a cassette unit in said housing, said cassette unit comprising:
a drum;
a cutting device incorporated in said drum;
a one-way bearing on a shaft of said drum enabling said drum to rotate only in one direction;
a tensioning device that tensions a strip of absorbent material passing between said tensioning device and said drum; and
a supply roll surface drive that controls rotation of a roll of absorbent material, said supply roll surface drive including plural pulleys and a first belt wrapped around said plural pulleys, said first belt contacting a roll of absorbent material along a plurality of contact points; and
a drive belt connected between one of said plural pulleys and said drum or said tensioning device.

15. The apparatus as claimed in claim 14, wherein the roll receiver includes a pair of removable support arms in an upper part of said housing, said pair of support arms holding a roll of absorbent material therebetween.

16. The apparatus as claimed in claim 14, wherein said supply roll surface drive further includes a lever and an elastic element attached to said lever, said lever being hingably movable so that said first belt remains in contact with a roll of absorbent material from an initial diameter of a roll of absorbent material to a second smaller diameter in which absorbent material is depleted from a roll of absorbent material.
